(19) United States
(12) Patent Application Publication
(10) Pub. No.: US 2014/0104318 A1
(43) Pub. Date: Apr. 17, 2014

(54) DISPLAY DEVICE FOR VEHICLE

(71) Applicant: CALSONIC KANSEI CORPORATION, Saitama-shi, Saitama (JP)

(72) Inventors: Kazuo Arai, Saitama (JP); Akihiro Eda, Saitama (JP)

(73) Assignee: CALSONIC KANSEI CORPORATION

(21) Appl. No.: 14/119,355

(22) PCT Filed: Apr. 25, 2012
(86) PCT No.: PCT/JP2012/061027

§ 371 Date: Nov. 21, 2013

(30) Foreign Application Priority Data
Jun. 24, 2011 (JP) 2011-140461
Dec. 27, 2011 (JP) 2011-284957

(51) Int. Cl. G06T 3/40

(52) U.S. Cl. CPC G06T 3/40
USPC 345/660

(57) ABSTRACT

A display device for a vehicle includes a display unit 3 arranged on an upper portion of an instrument panel 2 disposed under a front windshield glass 1, a magnifier 4 arranged at a rear side of the display unit 3 to show a magnified display image obtained by the display unit 3, and an opaque light shield wall 7 extending from the both edge portions of the display unit 3 to at least intersection points M, N of first lines LL1, LR1 respectively connecting the both eyes of a driver and the outer edge portions of the magnifier 4 and a second line L2 extending from the display unit 3 in a lateral direction of a vehicle.

### TECHNICAL FIELD

The present invention relates to a display device for a vehicle that is capable of displaying information on the vehicle and others to be informed to a user such as a driver with a high visibility.

### BACKGROUND OF THE INVENTION

A conventional display device for a vehicle is known in the patent document 1 listed below. In this conventional device, a light shading area, which becomes a shadow area where the light from a front side of a motor vehicle cannot pass through, is provided at a region between a lower side portion of a light shading masking part formed at the circumference of a front windshield glass of the motor vehicle and a front portion of an instrument panel thereof. A lighting display unit is arranged at a position of the light shading area that a driver can make a visual identification in order to show information on the vehicle. The lower portion of the light shading masking part functions as a light shading hood.

### PRIOR ART

### Patent Document

Patent Document 1: Japanese Patent Application Laid-Open Publication No. 2010-280247

### DISCLOSURE OF THE INVENTION

### Problem(s) to be Solved by the Invention

The conventional display device for the vehicles has problems described below.

In the conventional display device for the vehicles, eye points of a user such as a driver move in an upward and downward direction according to a physical size and a sitting position of the user. This causes a problem in that he or she cannot see a part of a display due to concealment by a projecting portion of a meter hood when the eye points are at a lower position.

On the other hand, a distance between the eye points of the user and the display device is considerably large, that is, 900 mm-1000 mm in a normal vehicle (an automobile). Accordingly, the letters and graphics to be displayed by the display unit need to be display in sizes larger than certain sizes in order that the user can visually identify them easily and within a short time. Such a large size of the letters and the graphics brings the display unit to become larger in size, so that its manufacturing cost increases. In addition, it impairs visibility of the front side of the vehicle.

The present invention is made to solve the above problems, and its object is to provide a display device for a vehicle where a user can make a visual identification of an entire display image produced by a display unit easily, surely, and in a short time, its size and manufacturing costs being suppressed.

### Means for Solving the Problems

To achieve the object, a display device for a vehicle according to claim 1 includes: a display unit that is arranged on an upper portion of an instrument panel under a passenger-compartment inner side portion of a front windshield glass; a magnifier that stands from an upper portion of the instrument panel and is allocated at a vehicular rear side of the display unit, the magnifier being capable of enlarging a display displayed by the display unit to show a display image to a driver; a light shield wall that is opaque, the light shield wall extending from the both outer edge portions of the display unit to at least a vicinity of left and right intersection points of first lines respectively connecting the both of left and right eyes of the driver and the outer edge portions of the magnifier with each other and a second line extending from the display unit in a lateral direction of the vehicle.

The display device for the vehicle according to claim 2 is characterized in that the light shield wall has a passenger compartment side surface in dark solid color.

The display device for the vehicle according to claim 3 is characterized in that an outer circumference of the magnifier enlarges the display displayed by the display unit.

The display device for the vehicle according to claim 4 is characterized in that the magnifier is inclined toward the front side of the vehicle.

The display device for the vehicle according to claim 5 is characterized in that a light refraction member is provided between the display unit and the magnifier to produce a display image obtained by shifting the display displayed by the display unit in an upper and lower direction.

The display device for the vehicle according to claim 6 is characterized in that the light refraction member employs a prism and this prism together with the magnifier shifts a light axis from the display unit downwardly.

The display device for the vehicle according to claim 7 is characterized in that the light refraction member employs a light refraction member that shifts the light axis from the display axis upwardly.

The display device for the vehicle according to claim 8 is characterized in that the magnifier is retractable into the instrument panel.

### Effect of the Invention

In the display device for the vehicle according to claim 1, the user can see the display, which is displayed by the display unit, that is enlarged by the magnifier, the light from the front side of the vehicle being shaded by the light shading wall with the above-mentioned width at the both sides in a lateral direction of the vehicle of the display. Therefore, the display device enables the user to visually identify the entire display displayed by the display unit easily and within a short time, decreasing its size and manufacturing cost.

In the display device according to claim 2, the both sides of the display displayed by the display unit in the lateral direction of the vehicle is painted in the dark solid color, so that the visual identification of the display is prevented from being disturbed.

In the display device according to claim 3, the meter hood of the instrument panel can prevent from the display through the magnifier from the occurrence of vignetting, so that the display unit can be arranged at a lower position.

The display device according to claim 4 prevents the vignetting due to the reflection on the magnifier, such as a driver's face and a driver's clothing, so the visibility of the display displayed by the display unit can be improved.

In the display device according to claim 5, the light refraction member shifts the display displayed by the display unit in the upper and lower direction to produce the image, so that it can avoid the vignetting due to the existence of the meter hood portion and the position of the eye points of the driver at a lower position.

In the display device according to claim 6, the light axis from the display unit can be refracted in vehicles with low positions of the eye points of the driver, so that the position of the display image is adjustable to those of the eye points of the driver.

In the display device according to claim 7, the display image of the display of the display unit is shifted upwardly. Therefore, it prevents vignetting of a part of the display of the display unit due to the meter hood portion, the driver can visually identify the display image.

In the display device according to claim 8, the magnifier behind the display unit is retracted into the instrument panel when the display unit is not used. Therefore, it can remove a consciousness of the existence of the magnifier and a mess feeling of the driver. In addition, it can avoid breakage of the magnifier by mistake.

### BRIEF DESCRIPTION OF THE DRAWINGS

FIG. 1 is a side view showing a construction of a display device for a vehicle of a first embodiment according to the present invention;

FIG. 2 is a plain view showing a relationship among a display unit, a light shading wall and a magnifier that are used in the display device of the first embodiment and right and left eyes of a driver;

FIG. 3 is a front view, which is seen from a driver's side, of the display and the light shading wall that are used in the display device of the first embodiment;

FIG. 4 is a view explaining about a problem generated in the relationship among the display unit, the magnifier, and the right and left eyes in a case where the display device is not provided with the light shading wall;

FIG. 5 is a plain view explaining about a problem generated in the relationship among the display unit, the magnifier, and the right and left eyes in a case where the display device is provided with the light shading wall;

FIG. 6 is a view explaining about an experiment that examines the effects of the magnifier in the display unit of the first embodiment;

FIG. 7 is a view showing a main part of a display device for a vehicle of a second embodiment according to the present invention;

FIG. 8 is a view explaining about an outer circumferential portion of a magnifier that is used in the display device of the second employment;

FIG. 9 is a view explaining about a problem caused due to reflected light on the magnifier of the display device in a case where the magnifier is arranged at position facing to a driver;

FIG. 10 is a view showing a main part of a display device for a vehicle of a third embodiment according to the present invention;

FIG. 11 is a view showing a main part of a display device for a vehicle of a fourth embodiment according to the present invention;

FIG. 12 is a view showing a main part of a display device for a vehicle of a fifth embodiment according to the present invention;

FIG. 13 is a view showing a main part of a display device for a vehicle of a sixth embodiment according to the present invention;

FIG. 14 is a view showing a modification of the main part of the display device for the vehicle of the sixth embodiment;

FIG. 15 is a view showing another modification of the main part of the display device for the vehicle of the sixth embodiment;

FIG. 16 is a view showing a main part of a display device for a vehicle of a seventh embodiment according to the present invention;

FIG. 17 is a view showing a modification of the main part of the display device for the vehicle of the seventh embodiment; and

FIG. 18 is a view showing a display unit, a light shading wall and a light refraction member of a main part of a display device for a vehicle of an eighth embodiment according to the present invention, where (a) is its front view and (b) is its side view.

### DESCRIPTION OF REFERENCE NUMBERS

1 front windshield glass
2 instrument panel
2a front side portion
2b rear side portion
2c defroster blow-out port
2d meter hood portion
3 display unit
4, 4′, 4″ magnifier
5 vehicle information computation part
6 display drive part
7, 12 light shading wall
8, 9 prism (light refraction member)
10, 11 refraction member (light refraction member)
EL position of left eye
ER position of right eye
LL1, LR1 first line
L2 second line
M, N point of intersection

### BEST MODE FOR CARRYING OUT THE INVENTION

Hereinafter, embodiments of the present invention will be explained in detail with reference to the accompanying drawings. Incidentally, the similar constructions in the embodiments are indicated by the same reference numbers, and their explanation is omitted. In addition, in every drawings, the paths of light passing through a lens 4 is illustrated as it does not refract, which is different from the actual ones, for the sake of convenience of explanation.

### First Embodiment

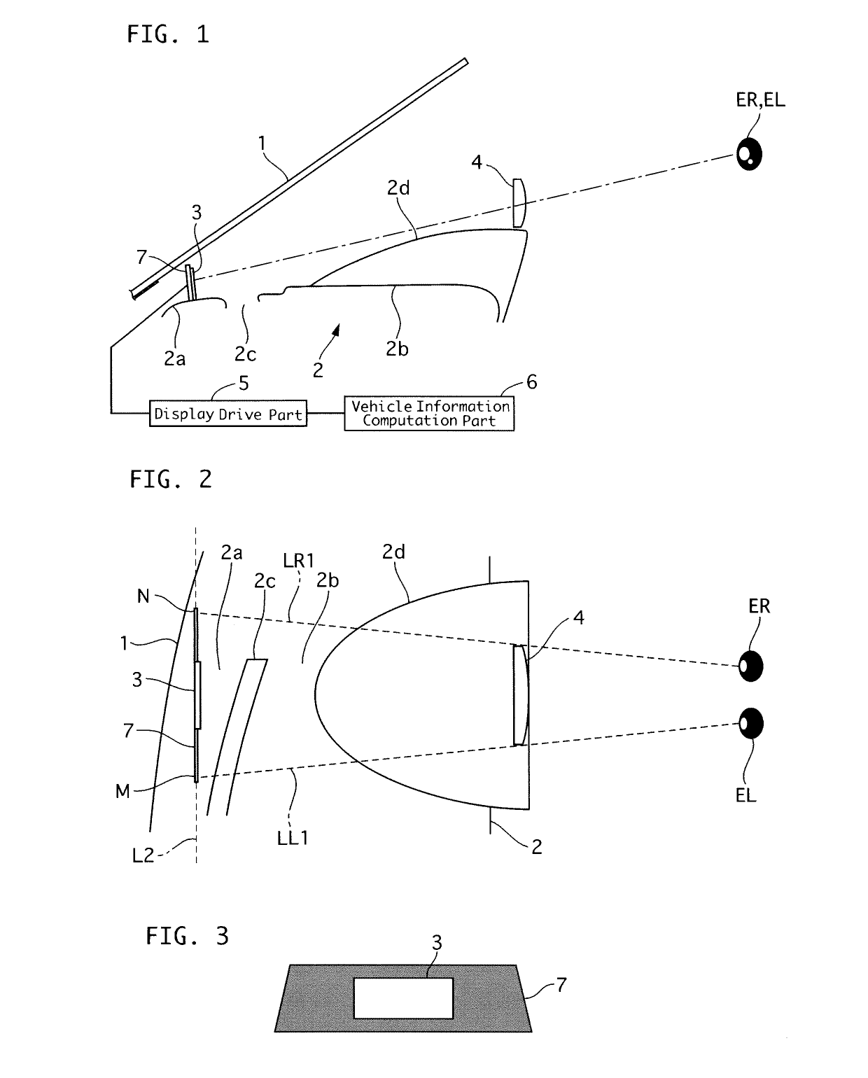

First, a construction of a display device for a vehicle of the first embodiment will be described with reference to the drawings of FIGS. 1 to 3.

The display device of the first embodiment is provided at a lower position of a lower portion of a front windshield glass 1 with a display unit 3 arranged at a front side of the vehicle of an instrument panel 2 and a magnifier 4 standing at a rear side of the vehicle of the instrument panel 2.

More specifically, the display unit 3 employs a liquid crystal display for example. It displays information on the vehicle on its screen, controlled by a drive signal from a display drive part 6 according to a vehicle information signal outputted from a vehicle information computation part 5, which are respectively arranged in the instrument panel 2.

The vehicle information computation part 5 is connected to various apparatus and devices such as audio system and air conditioning system on the vehicle, and the vehicle information obtained therefrom is sent to the display drive part 5 according to a driver's need.

The display drive part 6 produces a drive signal for driving the display unit 3 to display the vehicle information based on the vehicle information signal inputted from the vehicle information computation part 5.

On the other hand, the instrument panel 2 extends from an end to the other end of a passenger compartment in a lateral direction of the vehicle at the position in front of a not-shown driver's seat. It is provided with a front side portion 2a at the front side of a defroster blow-out port 2c, a rear side portion 2b at the rear side of the defroster blow-out port 2c, and a meter hood portion 2d that is formed by a part of the rear side portion 2b in front of the driver's seat being raised upwardly.

In the meter hood portion 2d, various meters such as a speed meter are arranged to face to a driver side.

A lower portion of the front windshield glass 1 adheres on a not-shown window frame of a vehicle body at a position in front of the front side portion 2a of the instrument panel 2. Incidentally, in order to avoid the deterioration of its adhesion bond due to ultraviolet light and improve its visual quality, the circumferential portion of the front windshield glass 1 is painted by masking, and it is fixed on the vehicle body with a window moulding.

The display unit 3 is arranged on the front side portion 2a of the instrument panel 2 to stand toward the lower portion of the front windshield glass 1 in a state where its display surface is headed for the rear side of the vehicle, that is toward the driver's side.

On the other hand, the magnifier 4 is set to have a width W4 larger than a width W3 of the display unit 3. This avoids the display image from vignetting generated due to the size of the magnifier 4 and/or when the positions of the driver's eyes (the left and right eyes EL, ER) move to a certain distance. The magnifier 4 is set to stand on an upper surface of the meter hood portion 2d of the instrument panel 2, and also on a line connecting the display unit 3 and the driver. Incidentally, the term “vignetting” means that a part of display image cannot be seen because the light cannot reach there.

As shown in FIGS. 1 and 3, alight shading wall 7 is provided on the front side portion 2a of the instrument panel 2 that is formed like a frame. It extends in the both right and left directions of the lateral direction of the vehicle, and it has the height slightly higher that of the display unit 3. The height of the light shading wall 7 is set so that it does not disturb the driver's visibility of the outside front of the passenger compartment.

In addition, as shown in FIG. 2, the length in the right and left direction of the light shading wall 7 is set long enough so that the left and right ends thereof is not positioned inside of the points M, N where a first line (a left eye side line LL1; a right eye side line ER1) respectively connecting the positions of the left and right eyes EL, ER with the left and right circumferential ends of the magnifier 4 intersects with a second line L2 extending in a width direction of the light shading wall 7.

Incidentally, the position of a driver's head moves in a certain area while he or she drives a vehicle. Accordingly, in order to determine the positions EL, ER of the left and right eyes, the positions are preferably set at the positions of the left and right eyes located when the driver's head is positioned at the most left and the most right, respectively.

A driver's side surface of the light shading wall 7 is painted in a dark solid color such as dark gray and black.

The operation of the thus-constructed display device of the first embodiment will be described below.

The driver sets the display device in an active state when he or she wants to see the information on the vehicle.

Then, the vehicle information computation part 5 inputs necessary information selected from the vehicle information obtained from the other units and devices on the vehicle as a vehicle signal to the display drive device 6. The display drive device 6 outputs a drive signal to the display unit 3 to display the vehicle information on its screen. The display displayed by the display unit 3 is enlarged by the magnifier located after the display unit 3 and it reaches the driver's eyes EL, ER. The driver can see the enlarged display instead of the display of the display unit 3 that is capable of displaying the display only in a narrow area. Therefore, the driver can visually identify the vehicle information surely and within a short time.

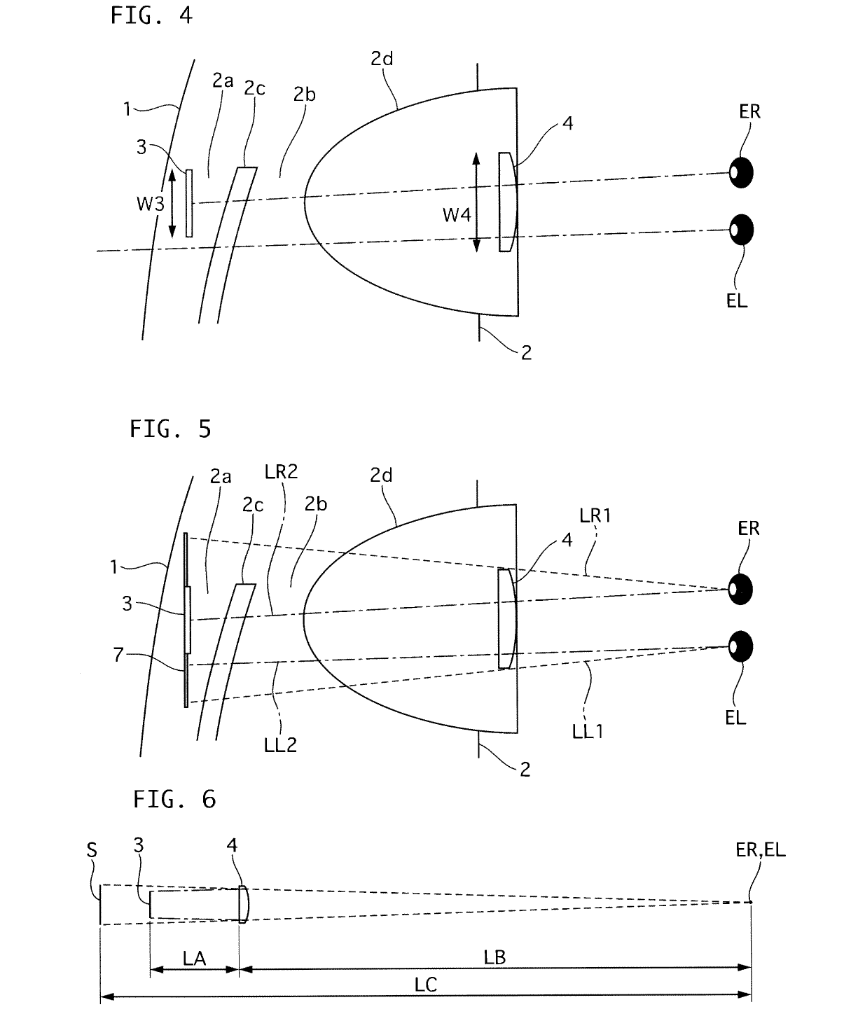

In this case, as shown in FIG. 4, if there is no light shading wall 7 at left and right of the display unit 3 like the first embodiment, there happens a state where the one eye (in FIG. 4 the right eye) of the driver sees the display on the display unit 3 through the magnifier 4 while the other eye (in FIG. 4 the left eye) sees the front outside view of the vehicle through the magnifier 4 and the front windshield glass 1. The respective lines of sight are indicated by dashed-dotted lines.

In this case, the right eye sees the display of the display unit 3 approximately 1 meter ahead, while the left eye sees the front outside view approximately several meters to several dozen meters ahead. That is, the right and left eyes see the images different in distance of sight. This is undesirable because the driver feels uncomfortable.

On the contrary, in the display device of the first embodiment, the light shading wall 7 is provided at the left and right of the display unit 3 to extend in the lateral direction of the vehicle to the vicinity of the intersection points M, N. The light shading wall 7 prevents the light from inputting from the outside front of the vehicle to the sides of the display unit 3 to improve the visibility of the display. In addition, the right eye of the driver sees the display on the display unit 3 approximately one meter ahead, and the left eye sees the light shading wall 7 approximately one meter ahead as shown in FIG. 5. In FIG. 5, the respective lines of sight are indicated by dashed-dotted lines LL2, LR2 in FIG. 5.

Therefore, the both eyes see objects almost same distance ahead, and the driver's side of the light shading wall 7 is painted in the dark solid color. Accordingly, they do not disturb visual identification of the display on the display unit 3, which differs from a case where the surface has elaborately-wrought one and is painted in a light color. This almost suppresses the uncomfortable feeling of the driver, improving the visual identification.

In order to confirm the performance of the display enlargement in the display device of the first employment, the experiment was made, where the display unit 3 and the magnifier 4 are arranged as shown in FIG. 6. In this experiment, the distance LA from the display unit 3 to the magnifier 4 is set 140 mm, the distance LB from the magnifier 4 to the positions of the driver's eyes (namely, eye points) is set 785 mm, the size of the display unit 3 is set 90 mm by 40 mm, and the magnifier 4 employs a lens with double-sided aspheric surfaces. The result is obtained, where the image S appears being enlarged 1.5 times as the display at the position the distance LC (998.5 mm) ahead of the positions of the eyes.

As explained above, in the display device of the first embodiment, the driver can see the enlarged image obtained by the magnifier 4 enlarging the display displayed by the display unit 3. In this case, there is the light shading wall 7 with the above-mentioned width at the both sides of the display unit 3 in the lateral direction of the vehicle, and accordingly no light is inputted from the outside front of the vehicle.

Thus, it can suppress the size of the display unit 3 and its manufacturing cost, providing a user such as a driver with the sure and easy visual-identification of the entire display within a short time.

### Second Embodiment

Next, a display device for a vehicle of a second embodiment according to the present invention will be described below.

The display device of the second embodiment uses the similar construction as that of the first embodiment, but the former is different from the latter in that the display displayed by the display unit 3 is mainly enlarged by an outer circumferential portion 4a of the magnifier 4. The other construction is similar to that of the first embodiment.

Herein, the magnifier 4 is formed by a part (in the embodiment, a portion shaped as a rectangle indicated by a solid line) of the outer circumferential portion 4a at the center portion indicated by a dotted circle in a convex lens 4′ in a circular shape shown in FIG. 8.

In case where the height of the display unit 3 is set sufficiently high when it is arranged, it cannot be seen through the magnifier 4. This brings the display unit 3 in clear view.

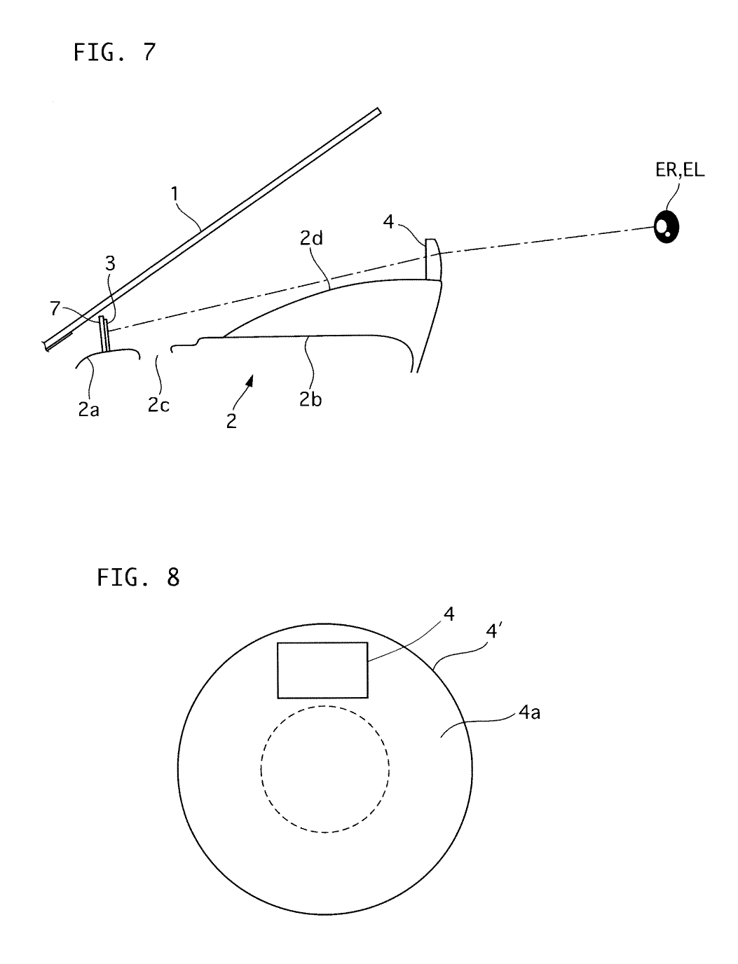

In the second embodiment, the display on the display unit 3 is, however, displayed mainly through the outer circumferential portion 4a of the magnifier 4, which refracts the light axes as well as a prism as shown in FIG. 7. Accordingly, in a case where the display unit 3 is located at a lower position, the driver can visually identify the display. The line of sight is indicated by a dashed-dotted line in FIG. 7. This enables the display unit 3 to be arranged at a low position where it maintains a low profile.

Incidentally, an inclined angle of the magnifier 4 relative to the instrument panel 2 is set adjustable, so that it can be adjusted according to the positions of the eyes in the upper and lower direction.

As understood from the above explanation, in the display device of the second embodiment, the outer circumferential portion 4a of the magnifier 4 mainly enlarges the display displayed by the display unit 3, so that it has the following effect in addition to those of the first embodiment.

It can avoid the vignetting of the display image produced by the magnifier 4 due to the meter hood portion 2d of the instrument panel 2.

### Third Embodiment

Next, a display device for a vehicle of a third embodiment according to the present invention will be described below.

The display device of the second embodiment uses the similar construction as that of the first embodiment, but the former is different from the latter in that an upper end side of the magnifier 4 is inclined toward the front side of the vehicle relative to the instrument panel 2. The other construction is similar to that of the second embodiment.

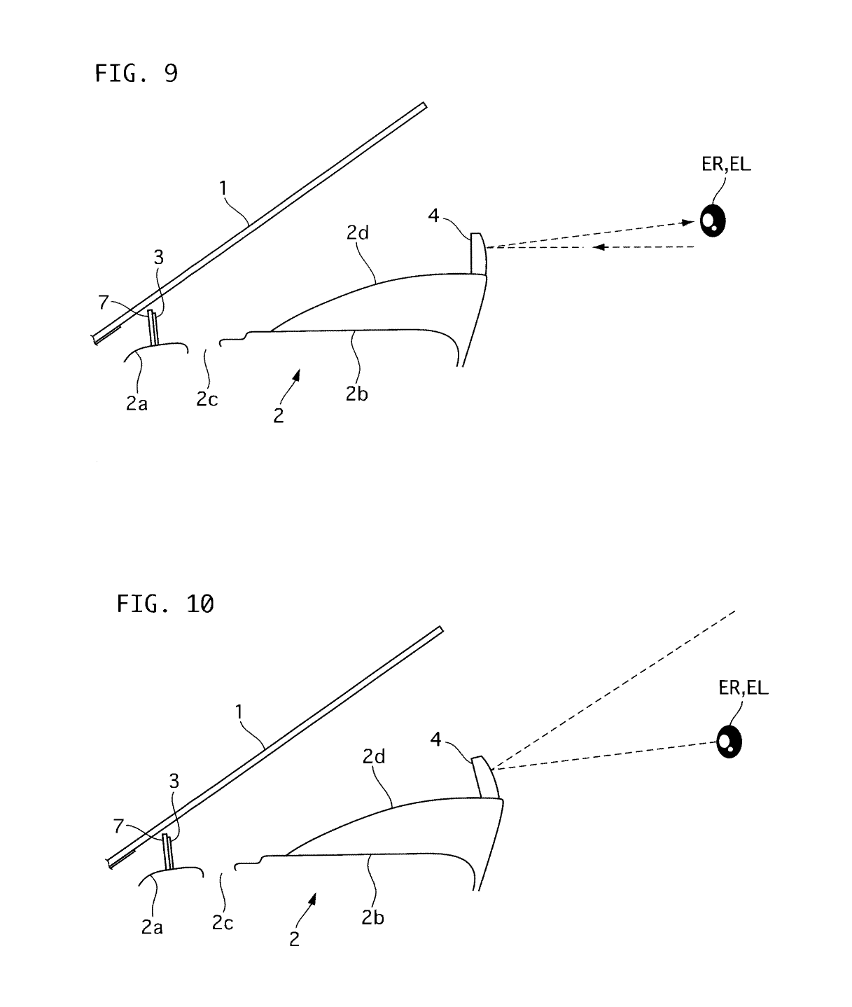

FIG. 9, where the light of sight due to reflection is indicated by a dashed line, shows, a case where the magnifier 4 is inclined relative to the instrument panel 2 such that the magnifier 4 faces to the eyes of the driver.

In this case, the magnifier 4 not only passes the light of the display on the display unit 3, but its surface at a driver's side reflects a face and a clothing of the driver. Accordingly, the reflection is overlapped with the display image, so that it becomes difficult for the driver to see the display image.

However, in the display device of the third embodiment, as shown in FIG. 10, where the line of sight due to the reflection is indicated by a dashed line, the magnifier 4 is inclined toward the front side of the vehicle relative to the instrument panel 2, so that what the driver's surface of the magnifier 4 reflects becomes a ceiling of the vehicle. The ceiling of the vehicle is normally painted by a solid color in dark or light gray.

Accordingly, in a case where the magnifier 4 reflects the light from the ceiling, its effect on the visual identification of the display image is small.

As understood from the above explanation, in the display device of the third embodiment, the magnifier 4 is inclined toward the front side of the vehicle relative to the instrument panel 2, so that it can avoid the vignetting of the face and clothing of the driver, improving the visibility of the display on the display unit.

### Fourth Embodiment

Next, a display device for a vehicle of a fourth embodiment according to the present invention will be described below.

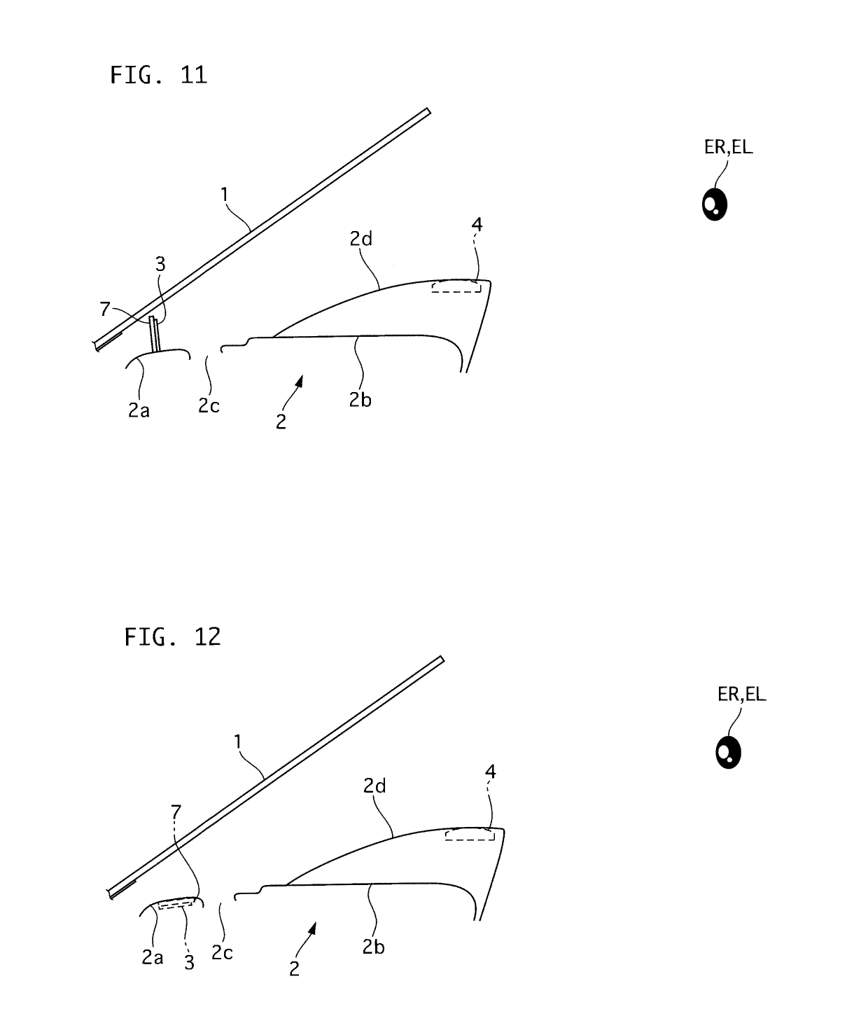

The display device of the fourth embodiment is constructed similarly to any one of the constructions of the first to third embodiments, while the magnifier 4 is capable of being retracted into the meter hood portion 2d of the instrument panel 2 when the driver does not use the magnifier 4 as shown in FIG. 11. In order to achieve this function, the magnifier 4 is tilted around the center of the lower portion of the magnifier 4 by the hand or by using a known electrical mechanism where it is rotated using a switch.

Preferably, the front side surface of the magnifier 4 is painted in the same color as that of the meter hood portion 2d of the instrument panel 2, and its configuration is formed to be continuous and integral with the meter hood portion 2a when it is retracted.

On the other hand, the screen has preferably a dark color such that the driver can see the screen and the light shading wall 7 around the screen in the similar colors.

### Fifth Embodiment

Next, a display device for a vehicle of a fifth embodiment according to the present invention will be described below.

As shown in FIG. 12, in the display device of the fifth embodiment, the display unit 3 and the light shading wall 7 are capable of being retracted into the front side portion 2a of the instrument panel 2 in addition to a construction of the fourth embodiment.

The magnifier 4, the display unit 3, and the light shading wall 7 are retracted into the rear side portion 2b and the front portion 2b of the instrument panel 2, respectively when they are not needed. This enables the front side of the driver to be simplified.

As understood from the above explanation, in the display device of the fifth embodiment, the magnifier 4 is retracted into the meter hood portion 2d of the instrument panel 2 when it is not needed, and the screen of the display unit 3and the light shading wall 7 surrounding the screen have outer appearances in the dark color that can be seen as the same one.

Therefore, it can remove a consciousness of the existence thereof and a mess feeling of the driver. In addition, it can avoid breakage of the magnifier 4 by mistake.

### Sixth Embodiment

Next, a display device for a vehicle of a sixth embodiment according to the present invention will be described below.

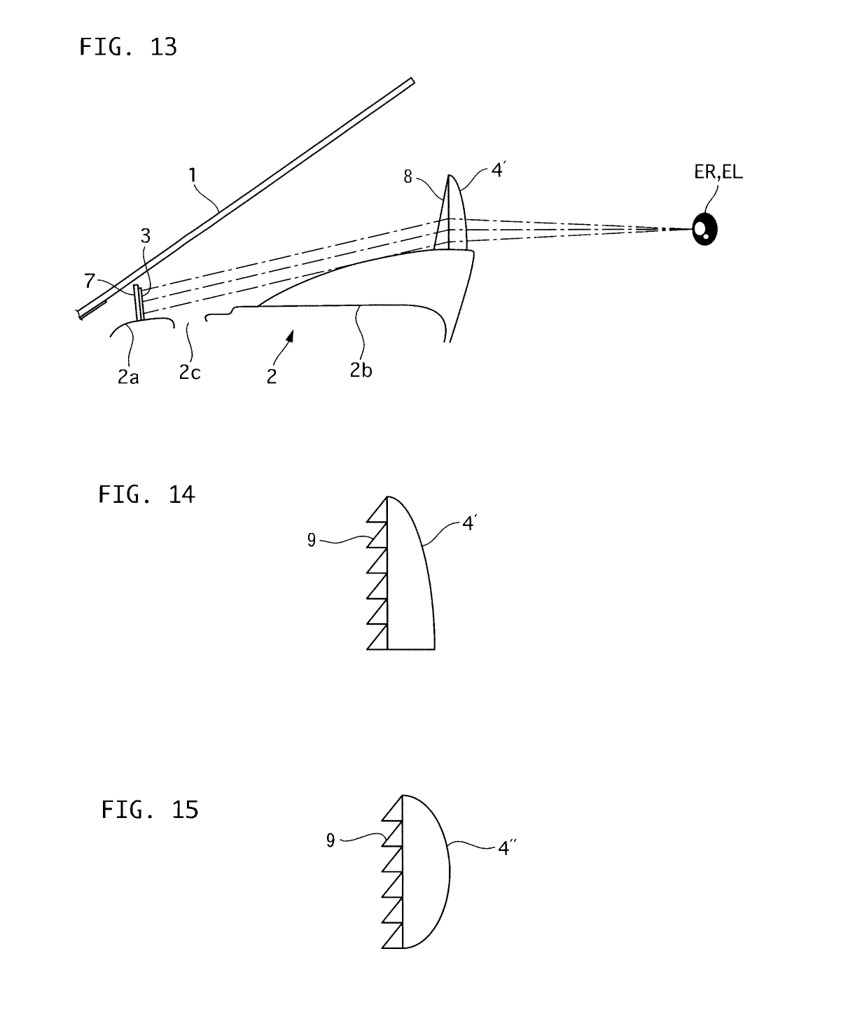

As shown in FIG. 13, in the display device of the sixth embodiment, a combination of the magnifier 4′ and a prism 8 is used instead of the magnifier 4 used in the first to fifth embodiment.

That is, the prism 8 is formed to have a slanted surface at the front side (a display unit side) of the vehicle in such a way that the length in the forward and rear direction of the prism increase as the height thereof becomes lower.

The surface at the rear side (a driver's seat side) of the vehicle is formed to be vertical.

The magnifier 4′ has a hemisphere face at the rear side of the vehicle and a vertical surface at the front side of the vehicle, and the vertical surface is integrally coupled with the vertical surface of the prism 6.

The other construction is similar to any one of those of the first to fifth embodiments.

In a case where the display on the display unit 3 is enlarged by the use of the magnifier of the first embodiment, the light axis is refracted as well as a prism mainly by using the outer circumferential portion of the magnifier 4.

Incidentally, the refractive index of the magnifier 4 is sometimes so small as the light cannot reach the positions of the eye points in a part of vehicles such as a sport car and a sedan where the eye points of drivers become relative low relative to the meter hood portion. In this case, it needs to increase the curvature of the magnifier 4 or incline the magnifier 4 toward the front side of the vehicle to increase the refractive index of the magnifier 4 so as to refract the light axis downwardly. There causes, however, a problem in that the image blurs in the former and the image is slanted in the latter.

On the contrary, in the display device of the sixth embodiment, the magnifier 4′ is added with a configuration for refraction of the prism 8, so that they can increase the refractive index without changing the curvature of an enlargement surface and the set angle of the magnifier 4′. Therefore, the light axis from the display unit 3 is refracted downward to a large amount by the use of the prism 8 and the magnifier 4′ to reach the eye points EL, ER of the driver at a low position.

As understood from the above explanation, the display device of the sixth embodiment can provide the following effect in addition to those of the first embodiment. The display can be enlarged without blur and inclination of the display image in the vehicles where the eye points of the driver are at the relatively low position relative to the meter hood portion.

In addition, the use of the prism 8 can be set to have a large refractive index, and in this case its configuration becomes to be easily formed.

Incidentally, the prism 8 and the magnifier 4′ of the sixth embodiment may be deformed from the one shown in FIG. 13 to the following one.

That is, as shown in FIG. 14, the magnifier 4′ is not changed and the prism 8 employs a prism 9 including a plurality of smaller prism that are piled up in the upper and lower direction so as to provide a Fresnel surface at the front side of the vehicle and a vertical surface at the rear side of the vehicle.

The vertical surface is integrally coupled with the front-side vertical surface of the magnifier 4′.

The thus constructed prism can refract the light axis from the display unit 3 downwardly compared to that in the first embodiment, suppressing it's the length thereof in the longitudinal direction of the vehicle.

In addition, as shown in FIG. 15, it may be constructed to includes the prism 9 with the Fresnel surface shown in FIG. 14 instead of the prism 8 shown in FIG. 13, and the magnifier 4″ with a vertical surface at the front side and a spherical surface at the rear side instead of the magnifier 4′ with the hemisphere face.

The thus constructed display device can refract the light axis from the display unit 3 more downwardly relative to the first embodiment.

Incidentally, in this modification, the refractive index becomes slightly smaller than that of the magnifier 4′, but it can suppress the deformation of the display image because of the use of the center portion of the enlargement surface of the magnifier 4′.

Incidentally, the prisms 8, 9 correspond to a light refraction member of the present invention.

### Seventh Embodiment

Next, a display device for a vehicle of a seventh embodiment according to the present invention will be described below.

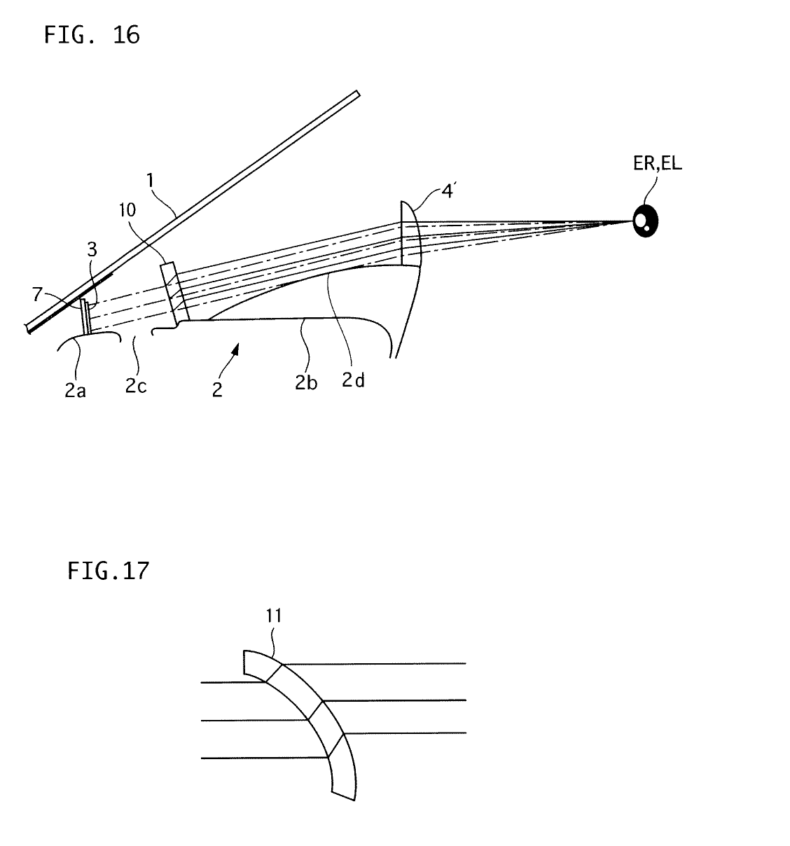

As shown in FIG. 16, in the display device of the seventh embodiment, a light refraction member 10 is arranged between the display unit 3 and the meter hood portion 2d where the light from the display unit 3 is reflected and between the display unit 3 and the magnifier 4′.

The light refraction member 10 is made of transparent glass, acrylic, polycarbonate, and the like, being formed like a plate member having plain surfaces parallel to each other at the both sides in the longitudinal direction of the vehicle. It is set on the instrument panel 2, being slanted toward the front side of the vehicle.

Consequently, the light axis from the display unit 3 is shifted upwardly by the light refraction member 10, and it reaches the magnifier 4′, passing over the meter hood portion 2d.

As understood from the above explanation, in the display device of the seventh embodiment, the light refraction member 10 shifts the light axis from the display unit 3 upwardly, and accordingly it can provide the following effects in addition to those of the first embodiment. The display device can avoid the vignetting of a part of the display image of the display unit 3 on the meter hood portion 2d.

In addition, the light refraction member 10 can be obtained as an transparent plate member with a simple structure, thereby decreasing its manufacturing cost.

Incidentally, in the seventh embodiment, the light refraction member 10 shown in FIG. 16 may be modified in such a way that it is replaced by a light refractive member 11 with hemisphere faces projecting more toward the front side as the height of the member 11 becomes higher.

In this case, the light is refracted in accordance with the curvature of the member 12 to shift the light axis upwardly. The amount of the shift is dependent on the configuration (the curvature), and accordingly the light refraction member 11 is needed to be made of transparent material and any quality of material may be used.

Therefore, in this modification, the upward-shift amount can be easily set by changing the curvature of the light refraction member 11.

### Eighth Embodiment

Next, a display device for a vehicle of an eighth embodiment according to the present invention will be described below.

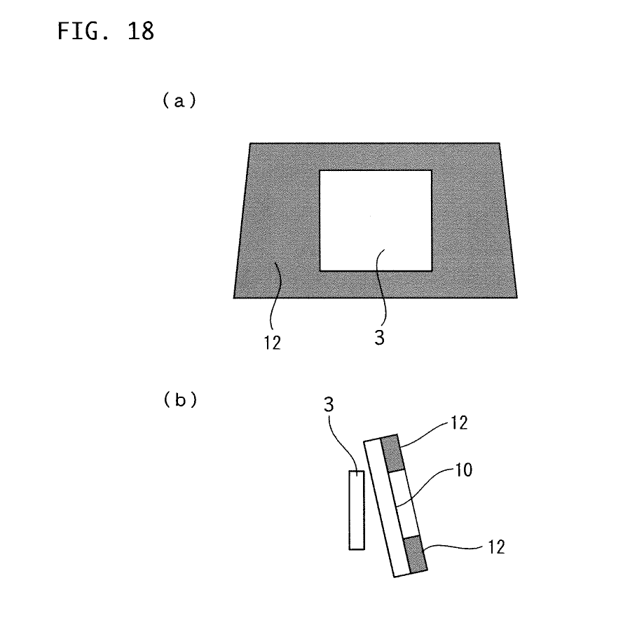

As shown in FIG. 18, in the display device of the eighth embodiment, the light shading wall 7 is integrally provided at the rear side of the light refraction member 10 with the member 10 in a state where the member 10 is slanted toward the front side as well as that shown in FIG. 16 instead of the construction (FIGS. 1-3) where the light shading wall 7 is integrally provided with the display unit 3.

Therefore, the display device of the eighth embodiment can provide the following effects in addition to those of the seventh embodiment.

It decreases a feeling of strangeness due to the existence of the light refractive member 10 at an immediate position between the display unit 3 and the magnifier 4′.

While the invention has been explained based on the embodiments, the invention is not limited to the embodiments. A design change and a modification are contained in the invention as long as they do not depart from the subject-matter of the invention.

For example, the display device for the vehicle according to the present invention is applied not only to automobiles, but to other typed vehicles.

Incidentally, the positions within the area where an area of small frequency is removed from the positions of various drivers are used as the positions ER, EL of the eyes in the display device. It may use other areas such as a range having a certain amount from the average positions.

In addition, the magnifier 4, the display unit 3, the light shading wall 7 and others can be retracted into the instrument panel 2 in the fourth and fifth embodiments, while they may be detachable from the instrument panel 2.

Further, the display unit 3 may employ, what is called, a smart phone.

1. A display device for a vehicle comprising:
a display unit that is arranged on an upper portion of an instrument panel under a passenger-compartment inner side portion of a front windshield glass;
a magnifier that stands from an upper portion of the instrument panel and is allocated at a vehicular rear side of the display unit, the magnifier being capable of enlarging a display displayed by the display unit to show a display image to a driver;
a light shield wall that is opaque, the light shield wall extending from the both outer edge portions of the display unit nit to at least a vicinity of left and right intersection points of first lines respectively connecting the both of left and right eyes of the driver and the outer edge portions of the magnifier with each other and a second line extending from the display unit in a lateral direction of the vehicle.

2. The display device for the vehicle according to claim 1, wherein
the light shield wall has a passenger compartment side surface in dark solid color.

3. The display device for the vehicle according to claim 2, wherein
the outer edge side portion of the magnifier enlarges the display displayed by the display unit.

4. The display unit for the vehicle according to claim 3, wherein
the magnifier is set to be inclined toward a front side of the vehicle.

5. The display unit for the vehicle according to claim 3, further comprising:
a light refractive member for producing an display image between the display unit and the magnifier, the display image being obtained by shifting the display displayed by the display unit in an upper and lower direction.

6. The display unit for the vehicle according to claim 2, wherein
the magnifier is set to be inclined toward a front side of the vehicle.

7. The display unit for the vehicle according to claim 2, further comprising:
a light refractive member for producing an display image between the display unit and the magnifier, the display image being obtained by shifting the display displayed by the display unit in an upper and lower direction.

8. The display unit for the vehicle according to claim 2, wherein
the magnifier is retractable into the instrument panel.

9. The display unit for the vehicle according to claim 1, wherein
the outer edge side portion of the magnifier enlarges the display displayed by the display unit.

10. The display unit for the vehicle according to claim 9, wherein
the magnifier is set to be inclined toward a front side of the vehicle.

11. The display unit for the vehicle according to claim 10, further comprising:
a light refractive member for producing an display image between the display unit and the magnifier, the display image being obtained by shifting the display displayed by the display unit in an upper and lower direction.

12. The display unit for the vehicle according to claim 9, further comprising:
a light refractive member for producing an display image between the display unit and the magnifier, the display image being obtained by shifting the display displayed by the display unit in an upper and lower direction.

13. The display unit for the vehicle according to claim 12, wherein
the light refractive member comprises a prism, and wherein
the prism and the magnifier refract a light axis from the display unit downwardly.

14. The display unit for the vehicle according to claim 12, further comprising:
the light refractive member comprises a light refractive member that shifts a light axis from the display unit upwardly.

15. The display unit for the vehicle according to claim 9, wherein
the magnifier is retractable into the instrument panel.

16. The display unit for the vehicle according to claim 1, further comprising:
a light refractive member for producing an display image between the display unit and the magnifier, the display image being obtained by shifting the display displayed by the display unit in an upper and lower direction.

17. The display unit for the vehicle according to claim 16, wherein
the light refractive member comprises a prism, wherein
the prism and the magnifier refract a light axis from the display unit downwardly.

18. The display unit for the vehicle according to claim 16, further comprising:
the light refractive member comprises a light refractive member that shifts a light axis from the display unit upwardly.

19. The display unit for the vehicle according to claim 16, wherein
the magnifier is retractable into the instrument panel.

20. The display unit for the vehicle according to claim 1, wherein
the magnifier is retractable into the instrument panel.
